(19) United States
(12) Patent Application Publication
(10) Pub. No.: US 2007/0240888 A1
(43) Pub. Date: Oct. 18, 2007

(54) Soil Treatment Apparatus

(75) Inventor: Philip Wright, Lincolnshire (GB)

Correspondence Address: BARNES & THORNBURG LLP, 11 SOUTH MERIDIAN, INDIANAPOLIS, IN, 46204, US

(73) Assignee: SIMBA INTERNATIONAL LTD., SLEAFORD LINCOLNSHIRE, UNITED KINGDOM ng (GB)

(21) Appl. No.: 11/570,532

(22) PCT Filed: May 24, 2005
(86) PCT No.: PCT/GB05/02041

§ 371 Date: Dec. 13, 2006

(30) Foreign Application Priority Data
Jun. 16, 2004 (GB) 0413462.3

(51) Int. Cl. A01B 29/04

(52) U.S. Cl. 172/21

(57) ABSTRACT

A soil treatment apparatus (100) comprises a ring (114) having a first ring part (128) and a second ring part (128). An elastomeric clamping arrangement (116) comprising rubber annular parts (116) and end flanges (112) clamp the first and second ring parts (128) together to form the ring (114) and provide an axial compressive force on the parts. In another aspect, the ring is carried on the elastomeric clamping arrangement (116) to absorb shock loading on the ring.

The invention relates to a soil treatment apparatus and particularly, although not exclusively limited to, a soil consolidation apparatus. The invention also relates to a method of manufacturing a soil treatment apparatus.

It is known to provide a press cultivator for breaking down and consolidating ploughed ground prior to sowing the seeds. Such press cultivators conventionally comprise one or more rows of press rings which consolidate and slice the clods remaining from ploughing, facilitating subsequent weathering effects and enabling the soil to be broken down into a seed bed more easily. The benefit of firming the soil profile, after disturbance by plough or disc, is to make subsequent trafficking and cultivation easier and more effective and to render the soil profile more effective in accepting water by improving capillary action.

Traditional press cultivators used spoked cast-iron press rings which were disadvantageous because they were heavy and prone to wear. An improved press ring was proposed in applicants British patent No. 2323511. In GB2323511 a press ring for an agricultural machine comprises two opposing dish-like members, each having a substantially circular base and an outwardly curving peripheral wall. The wall comprises a wall portion extending radially and axially out from the base and a ground cutting rim portion extending substantially radially out from the wall portion. The dish-like members are provided concave with respect to one another held together by clamping on an axle. The benefits of that roller include the provision of a corrugated soil profile which is weather proof, the cutting of clods by virtue of the peripheral rim and the crushing and breaking down of clods with the wall portion. However, such rings are still relatively heavy which limits their application to larger trailed machines. It would be desirable to provide a system which could operate on smaller hitch mounted machines, the weight of the press ring on an axle is often too great for the tractor pulling the equipment safely to raise the equipment above the ground for turns and for transportation.

The assembly of the rings on an axle is a skilled operation which increases the complexity and cost of the assembly. The known rings tended to leave a small unconsolidated ridge of soil and, in turn, the space between pairs of discs can fill with soil which requires the addition of a scraper. Also, the solid nature of the ring cannot absorb shock loads for example when the cultivator strikes a stone. Still further, the specific mounting arrangement for the press rings limits the axial length for a set of rings to two metres which increases the overall frame complexity.

It is also known to mount conventional cast-iron press rings on an axle with rubber tyres carried on the axle therebetween. The tyres serve to restrict the material which may enter the space between the rings and also consolidates the ground between the rings. However, that does not overcome the problem of high weight and the rings are still rigidly mounted to the axle so they cannot absorb shock-loading. It is also known to mount a wheel on an axle having a wheel hub and an elastomeric tyre wherein a protruding rim is mounted directly to the hub. Such an arrangement was made by the Otico Company of Longueville, France under their trade mark OTIFLEX. Again, when the protruding rim contacted a rigid object, such as a stone, the shock of that contact was transmitted directly to the axle and there was no way for that implement to absorb the shock.

It is an object of the invention to provide an improved soil treatment apparatus.

According to a first aspect of the invention there is provided a soil treatment apparatus comprising an annular elastomeric body defining an outer soil treatment surface and an annular metal rim mounted on the elastomeric body so that at least part of the rim protrudes radially outwardly of the outer soil treatment surface.

In that way, the metal rim is provided to cut clods in the soil and the elastomeric body acts to consolidate the soil surface but by mounting the metal rim on the elastomeric body, when the metal rim impacts stones and other rigid objects the shock of the impact is absorbed by the elastomeric body.

The elastomeric body may be provided in two parts, one part on one side of the metal rim and the other part on the other side of the metal rim. Preferably the parts are compressed together around the metal rim.

In another embodiment, the elastomeric body is provided in one part. In such a case, the metal rim is preferably in-moulded with the body.

In either case, the body may include a first portion arranged on one side of the rim and the second portion arranged on the other side of the rim in an axial sense. In other words, extending in an axial direction of the annular body there is the first portion of the annular body, then the metal rim, then a second portion of the annular body.

According to a second aspect of the invention there is provided a soil treatment apparatus comprising an annular elastomeric body and an annular metal rim mounted on the elastomeric body, the elastomeric body having a first portion arranged on one side of the rim and a second portion arranged on the other side of the rim in an axial sense.

The elastomeric body is preferably at least partly frustoconical in section. Most preferably, the elastomeric body comprises a cylindrical portion and a frustoconical portion. In the most preferred embodiment, the soil treatment apparatus comprises an annular elastomeric body having a first portion comprising a cylinder and a frustocone tapering outwardly from the cylindrical portion, the metal rim being mounted to the enlarged diameter part of the frustocone, the elastomeric body comprising a second portion on the other side of the metal rim, with the metal rim mounted to an enlarged diameter part of the frustocone which tapers inwardly away from the metal rim towards a cylinder. Most preferably, the first portion and second portion are mirror images of each other. When two such apparatus are arranged axially together, end-to-end, then the profile between the two metal rims is in the shape of a diabolo. Although the taper portion has been described as being frustoconical, it could equally be convexly or concavely tapered.

The inner diameter of the annular metal rim is preferably greater than the inner diameter of the annular elastomeric body. The annular metal rim is preferably mounted on the annular elastomeric body at the inner diameter of the elastomeric body.

The annular metal rim preferably includes a plurality, preferably 3 or more, of pads which extend inwardly from the inner side of the annular rim so as to define the aforesaid inner diameter.

The outer side of the rim may be entirely circular but is preferably a crenelated circle.

The soil treatment apparatus is preferably mounted on an axle, with the annular elastomeric body being mounted on the axle by means of interference fit and the annular metal rim being mounted to the elastomeric body with a clearance between the inner diameter of the rim and the axle.

According to a third aspect of the invention there is provided a soil treatment apparatus comprising an axle, an annular elastomeric body mounted directly on the axle and an annular metal rim mounted on the elastomeric body. The axle is preferably mounted in a rotatable fashion on a frame. The frame may include road-going wheels and be trailed or it may be mounted directly to the hitch arrangement of a tractor.

Preferably the apparatus comprises a first annular elastomeric body with a first annular metal rim mounted thereon on an axle and a second annular elastomeric body having a second annular metal rim mounted thereon, on the axle, the first and second annular elastomeric bodies being axially compressed together. That assists in retention of the metal rims and also prevents ingress of matter between the elastomeric bodies.

According to a fourth aspect of the invention there is provided a soil treatment apparatus comprising an axle, a first annular elastomeric body having a first annular metal rim mounted thereon and a second annular elastomeric body having a second annular metal rim mounted thereon, the first and second annular elastomeric bodies being axially compressed together.

Obviously, further additional annular elastomeric bodies having annular metal rims mounted thereon may be provided.

According to a fifth aspect of the invention there is provided a method of manufacturing the soil treatment apparatus comprising the steps of providing a mould for moulding a body of the apparatus, providing a metal rim of the apparatus, placing the metal rim in the mould and moulding the body around the rim.

In a preferred embodiment of the fifth aspect of the invention, the method includes the step of moulding the body from an elastomeric material.

The elastomeric material is preferably a polymer material, most preferably polyurethane, although natural or synthetic rubber could be used.

The metal is preferably mild steel or wear resistant steel.

According to a sixth aspect of the invention, there is provided a soil treatment apparatus comprising a metal ring and an elastomeric clamping arrangement arranged to provide an axial compressive force on the ring.

Although it is known to clamp together dish-like members to form press rings, as described in GB2323511 to provide a “self-sharpening” function whereby the dish members are pushed together when the rim wears down so that wear at the peripheral edge is taken up, it is not known to use an elastomeric material to provide that clamping arrangement. Use of an elastomer has several advantages over the known clamping method.

Firstly, use of the elastomeric clamping arrangement between pairs of rings on an axle ensures even distribution of the compressive load across an axle. It also ensures that the centres on which the rings are aligned are maintained, regardless of wear.

Furthermore, in the previous arrangement, when the rings were initially installed on the axle and clamped up, there was a tremendous amount of energy stored in the rings and clamps which meant that disassembly of the device in that state required exceptional care to be taken to avoid damage to equipment or injury. Only when the rings were worn down was that stored energy used up. By using an elastomer, although the energy is stored in the elastomer, there is considerable hysteresis in its behaviour. Thus, the elastomer will return to its original position when the compression is released but only after some time has passed which is sufficient to avoid the kind of hazard that may be present in the previous system.

The use of an elastomer also allows the ridge formed between rings to be rolled and by moulding the elastomer into particular forms an appropriate ridge profile can be selected.

The first and second parts preferably each comprise a circular base, a radially and axially extending wall part and a substantially radially extending rim part. The first and second parts are preferably arranged so that their respective rim parts are in contact.

Each ring part comprises substantially circular base and an outwardly curving peripheral wall. The wall comprises a wall portion extending radially and axially out from the base and a ground cutting rim portion extending substantially radially out from the wall portion. The ring parts are provided concave with respect to one another and are held together by clamping on an axle.

The first and/or second ring parts may be mounted on the elastomeric clamping arrangement.

The apparatus is preferably arranged on an axle. Where the ring parts are mounted on the elastomeric clamping arrangement, the elastomeric clamping arrangement is preferably arranged on the axle and the ring parts mounted on the elastomeric clamping arrangement.

The elastomeric clamping arrangement preferably comprises a first elastomeric piece on one side of the ring and a second elastomeric piece on the other side of the ring.

Most preferably, the soil treatment apparatus comprises a ring comprising first and second ring parts arranged on an axle, an elastomeric clamping arrangement comprising a first elastomeric piece on one side of the ring and a second elastomeric piece on the other side of the ring, a first stop attachable to the axle on one side of the ring against which the elastomeric clamping arrangement abuts and a second stop attachable to the axle on the other side of the ring against which the elastomeric clamping arrangement abuts. A plurality of sets of ring parts and elastomeric clamping arrangements may be arranged on an axle between the two stops. The axle preferably has an outer diameter greater than half the diameter of the ring. One or both of the stops may be end flanges.

The ring parts are preferably made from wear resistant steel. The elastomeric clamping arrangement may be made from any suitable elastomer. Preferably natural or synthetic rubber is used, most preferably, recycled vehicle tyre material is used.

Where two rings are provided, the elastomeric clamping arrangement comprises a first elastomeric piece on one side of the first ring, a second elastomeric piece between the two rings and a third elastomeric piece on the opposite side of the second ring. Where more than two rings are provided, a single elastomeric piece is provided between each pair of rings.

It is envisaged within the scope of the invention that the outermost ring on an axle abuts directly against the respective stop or that an elastomeric piece be arranged between the respective stop and end ring.

A soil treatment apparatus in accordance with the above aspects of the invention will now be described in detail by way of example and with reference to the accompanying drawings, in which:

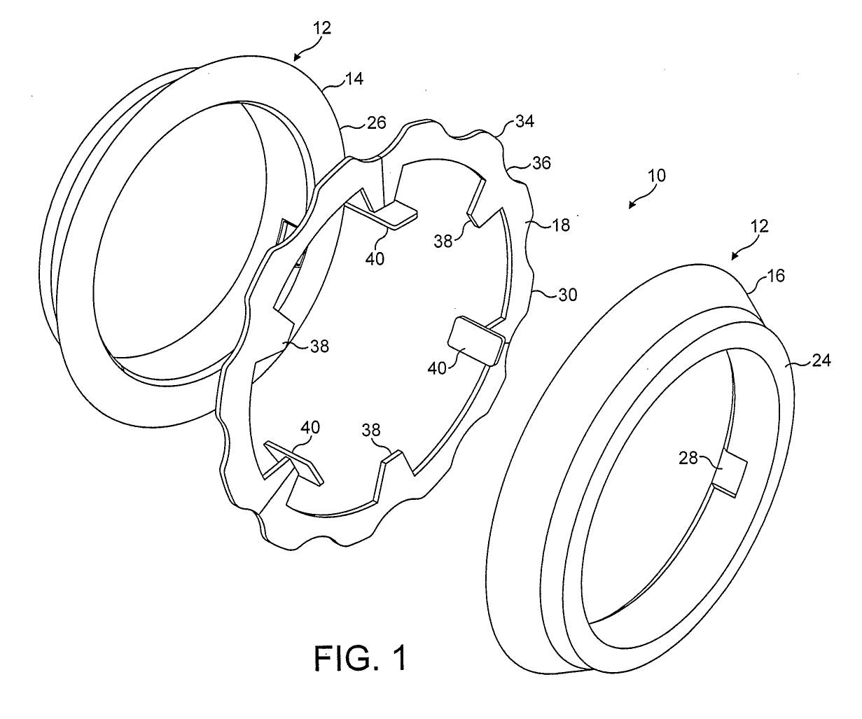

FIG. 1 is an exploded perspective view of a soil treatment apparatus in accordance with the first and second aspects of the invention,

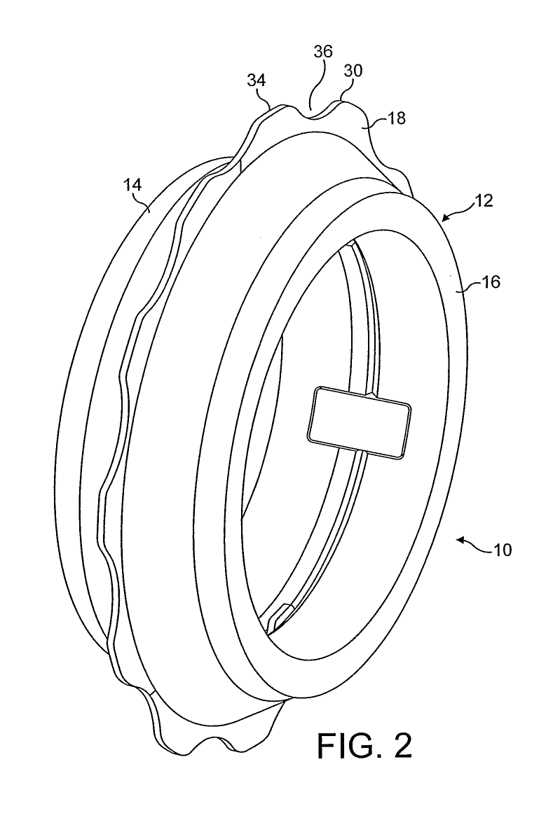

FIG. 2 is a perspective view of the soil treatment apparatus of FIG. 1, shown assembled together,

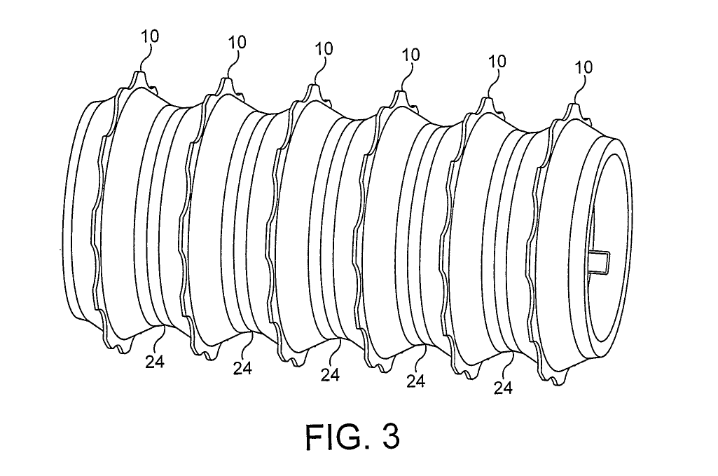

FIG. 3 is a perspective view of a plurality of the soil treatment apparatus of FIGS. 1 and 2 shown grouped axially together,

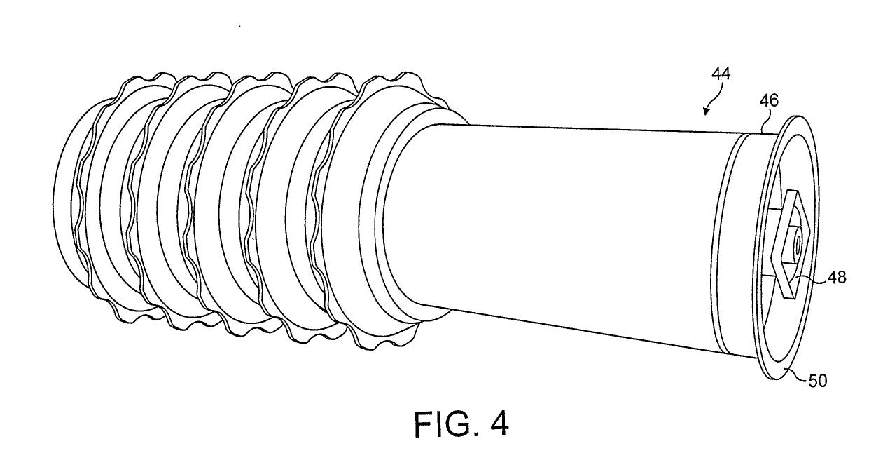

FIG. 4 is a perspective view of the soil treatment apparatus of FIG. 3 arranged on an axle so as form a soil treatment apparatus in accordance with the third and fourth aspects of the invention,

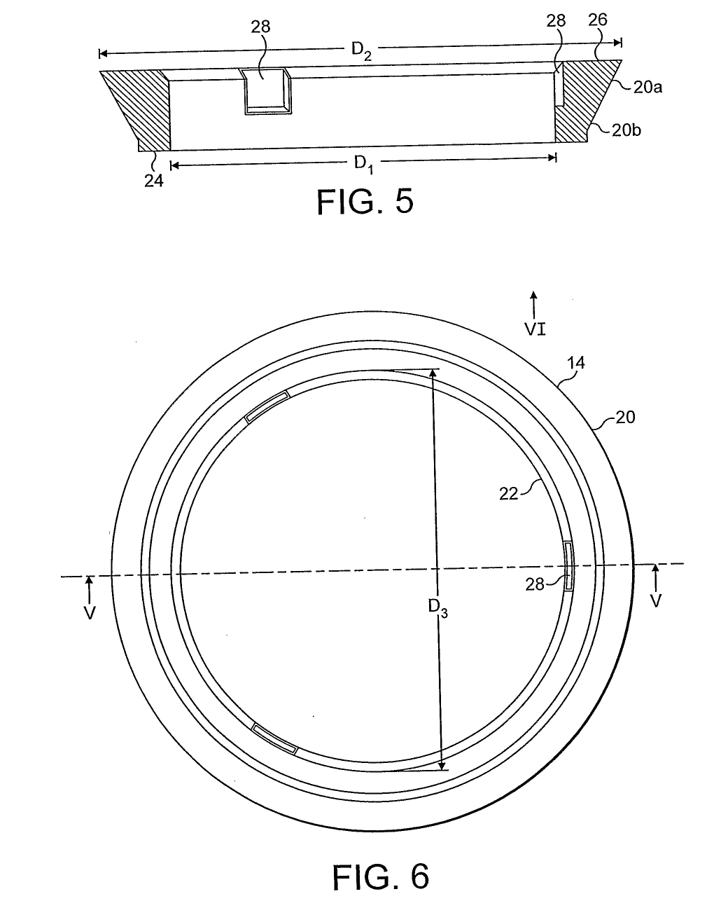

FIG. 5 is cross-section taken through the annular elastomeric body on line V-V in FIG. 6,

FIG. 6 is an end elevation looking in the direction of arrow VI in FIG. 5,

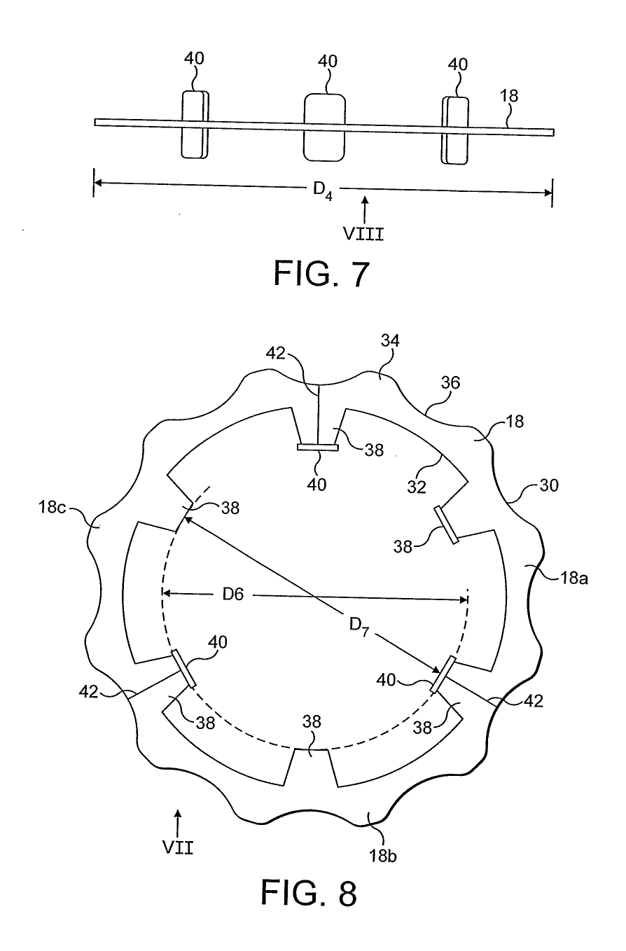

FIG. 7 is a side elevation of the annular metal rim looking in the direction of arrow VII in FIG. 8,

FIG. 8 is an elevation looking in the direction of arrow VM in FIG. 7, and

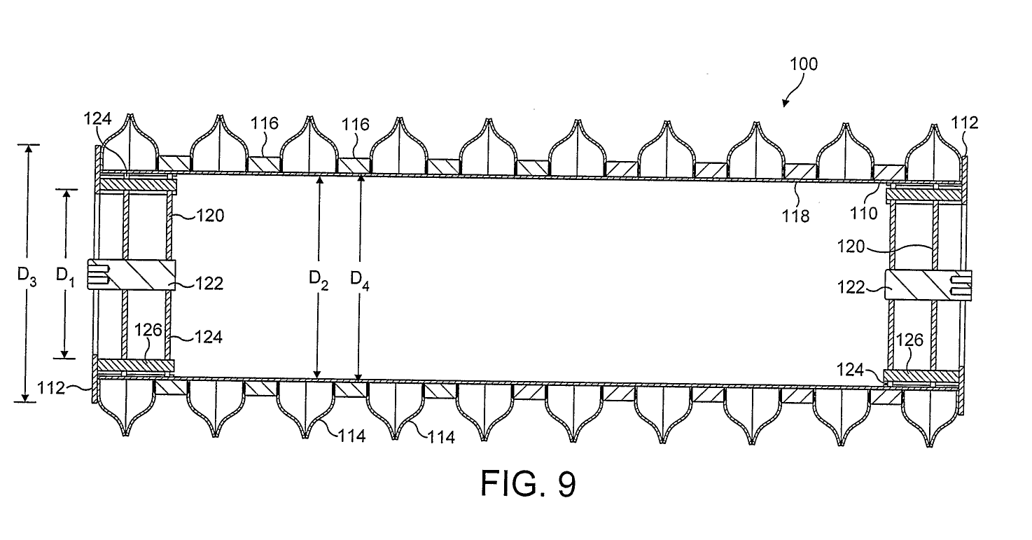

FIG. 9 is a cross-sectional view of a soil treatment apparatus in accordance with the sixth aspect of the invention,

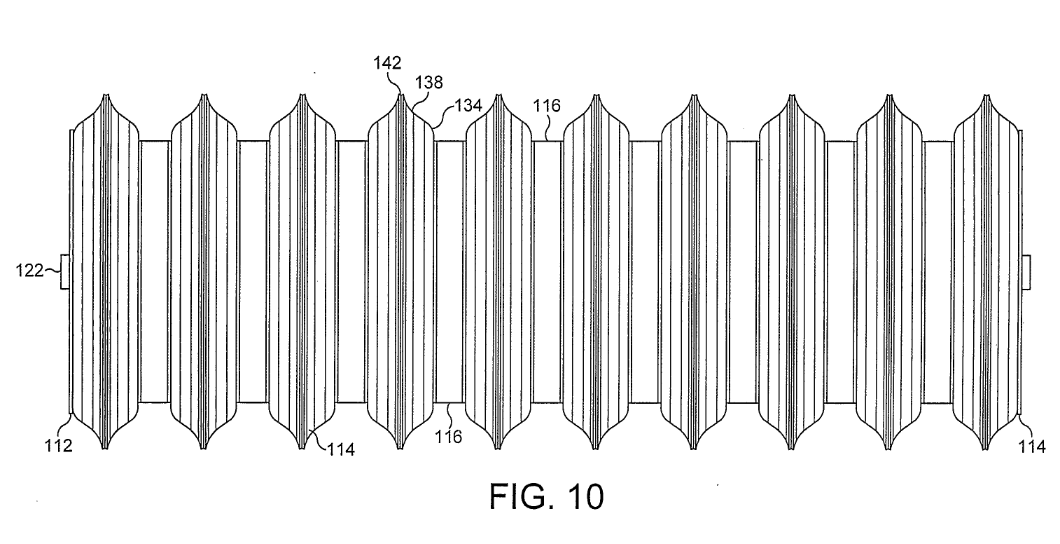

FIG. 10 is an end elevation of the apparatus of FIG. 9,

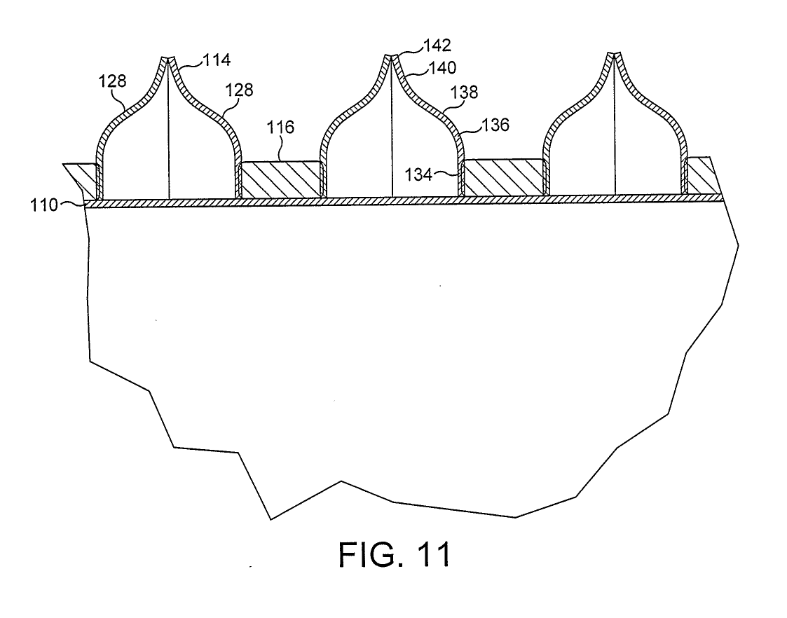

FIG. 11 is a cross-sectional view of part of the apparatus of Figs.9 and 10 shown to a larger scale,

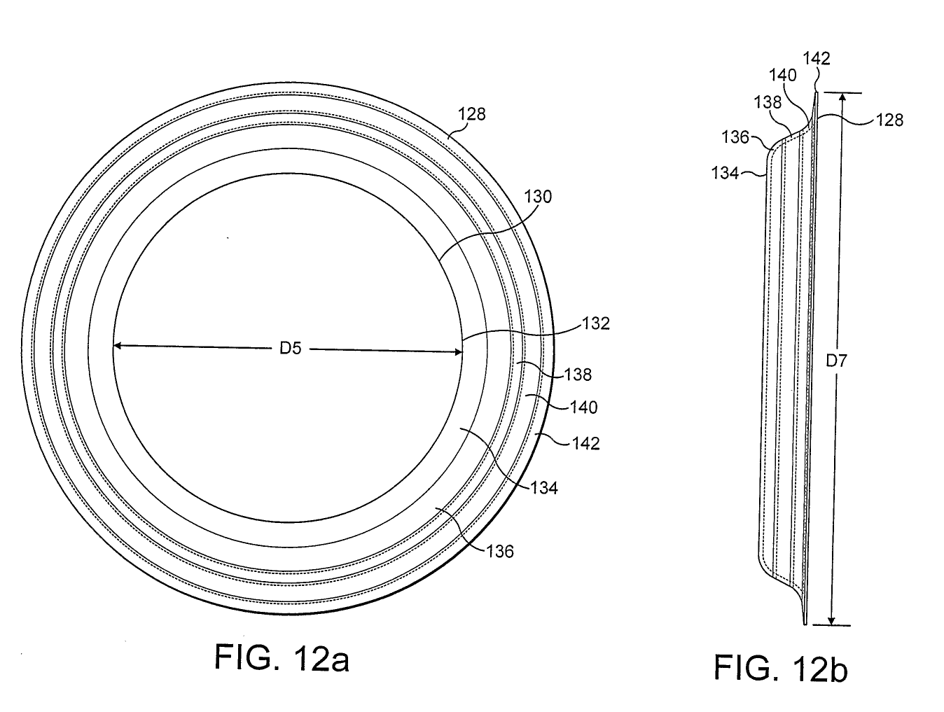

FIGS. 12a and b are side and end elevations of a ring part used in the apparatus of FIGS. 9 to 11,

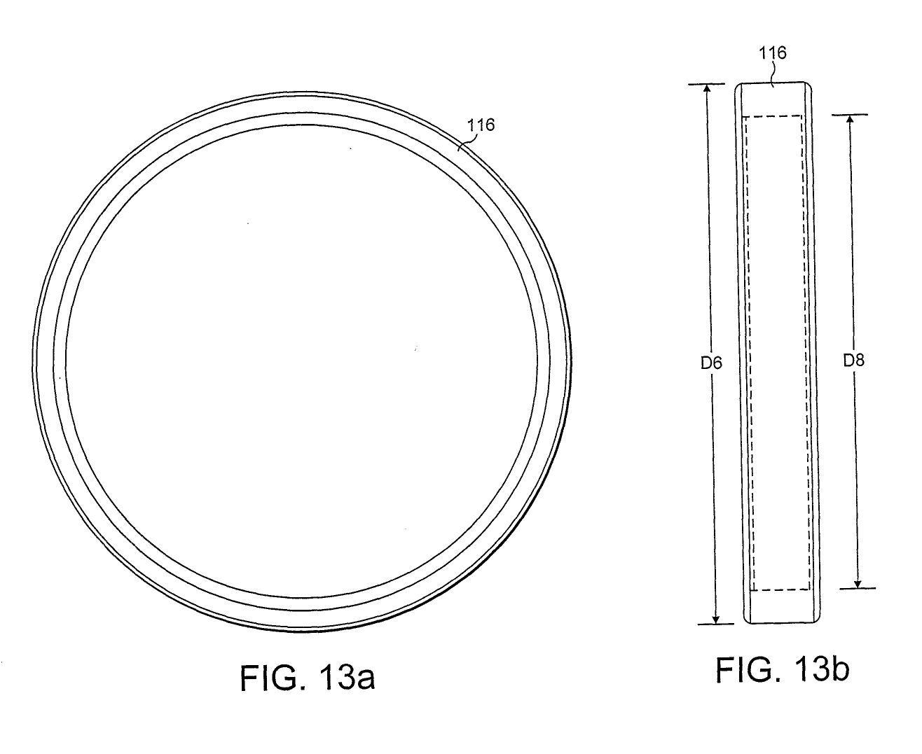

FIGS. 13a and b are side and end elevations of an elastomeric piece used in the apparatus of FIGS. 9 to 11,

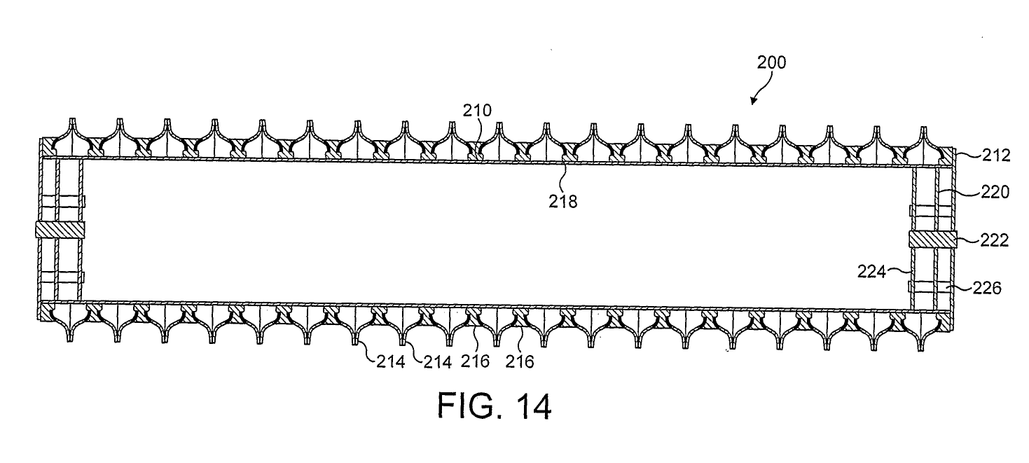

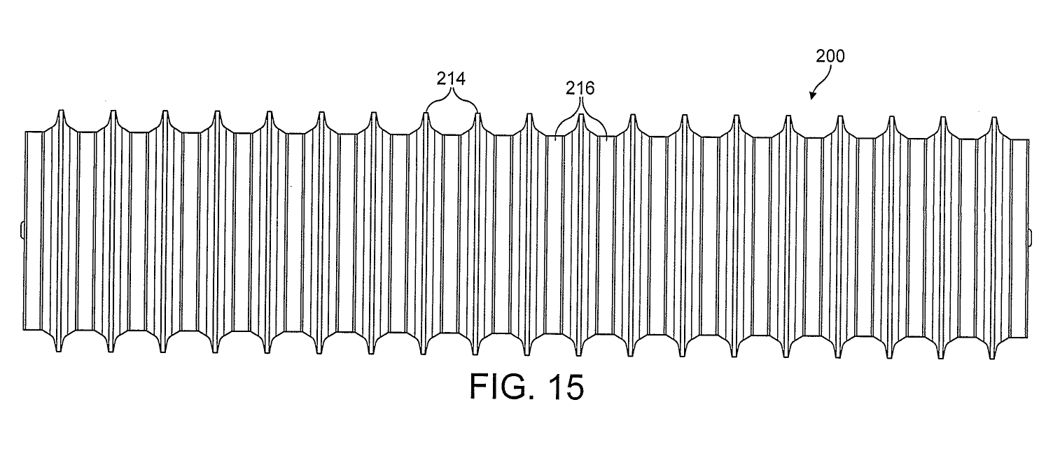

FIG. 14 is a cross-sectional view of a soil treatment apparatus in accordance with the first, second, third, fourth and sixth aspects of the invention,

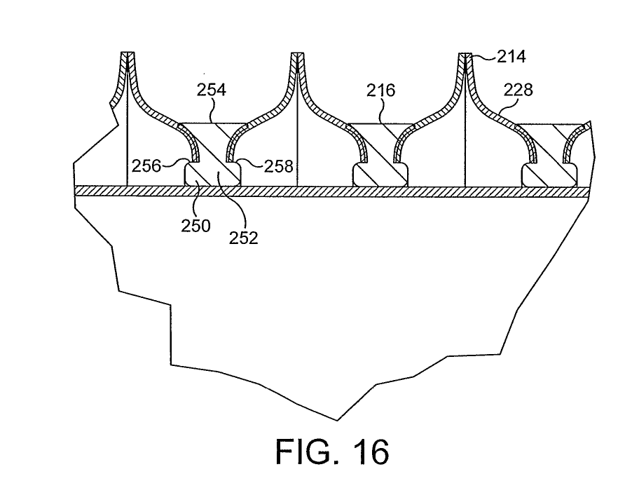

FIG. 15 is an end elevation of the apparatus of FIG. 14,

FIG. 16 is a cross-sectional view of part of the apparatus of FIGS. 14 and 15 shown to a larger scale,

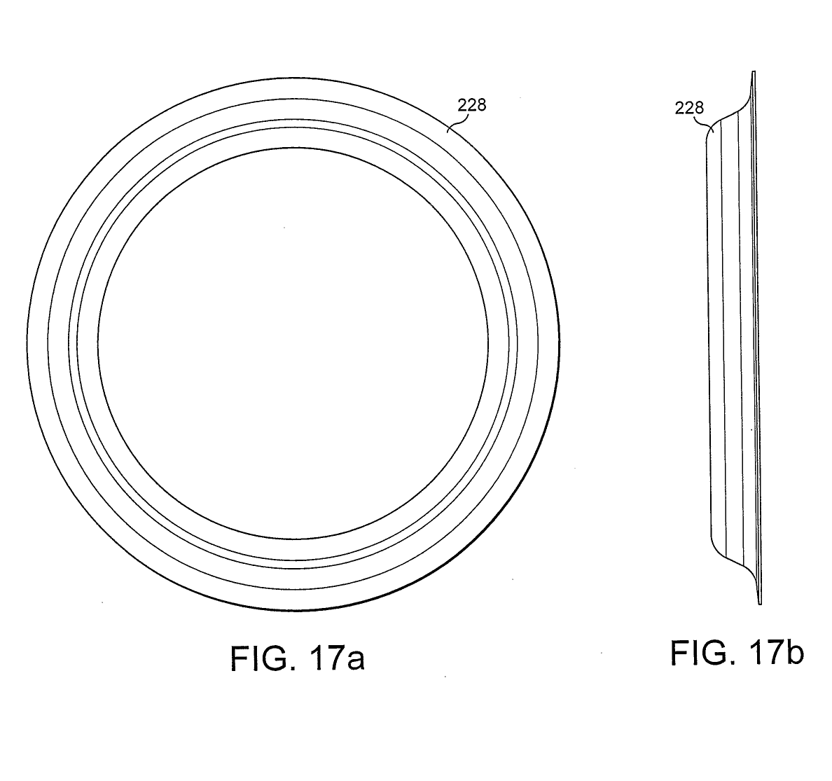

FIG. 17a and b are side and end elevations of a ring part used in the apparatus of FIGS. 14 to 16, and

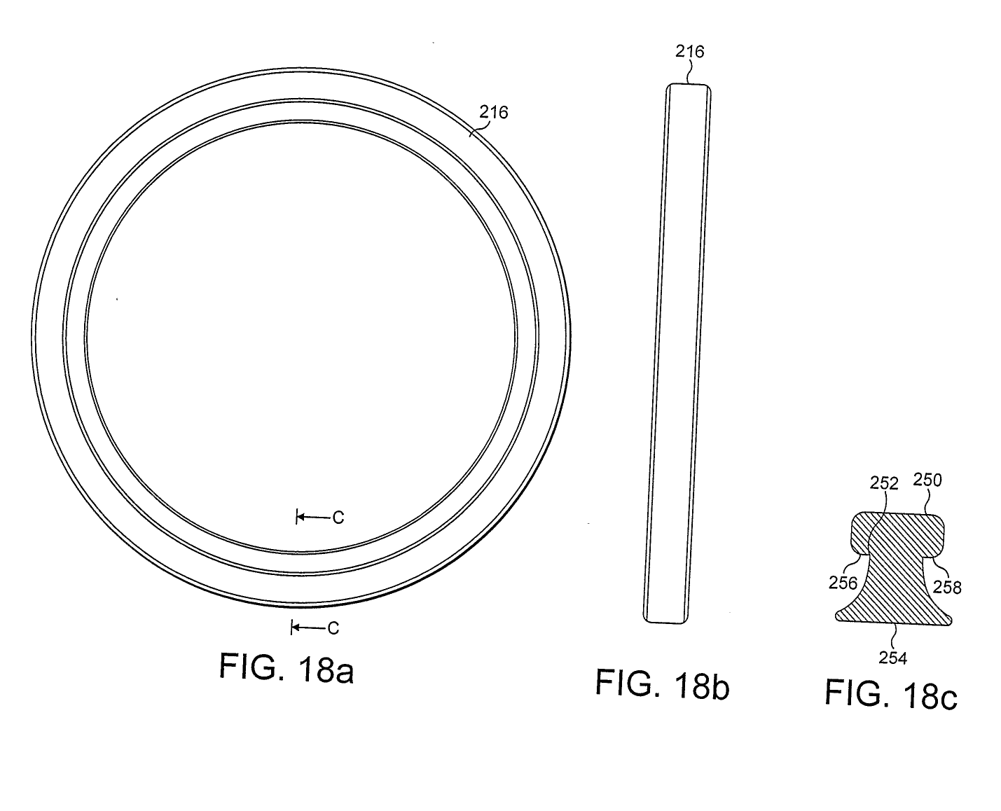

FIGS. 18a, b, c are side and end elevations and a cross-section of an elastomeric piece used in the apparatus of FIGS. 14 to 16.

In FIG. 1 a soil treatment apparatus, generally indicated at reference numeral 10 comprises an annular elastomeric body 12, which is arranged in two parts, 14, 16 and an annular metal rim 18.

As shown in FIG. 2, the first and second parts 14, 16 of the annular elastomeric body sandwich the metal rim 18 in such a way that part of the metal rim protrudes radially from the elastomeric body 12.

The elastomeric body part 12 is shown in FIGS. 5 and 6 in detail.

In FIG. 6, the elastomeric body part 14 is an annulus with an outside surface 20 and an inside surface 22.

The inside surface 22 defines a body inside diameter D1 (see FIG. 5). The inner surface 22 is substantially cylindrical.

The outer surface 20 has a frustoconical portion 20a and a substantially cylindrical portion 20b. The transition between the frustoconical portion and the cylindrical portion is preferably radiused. The frustoconical portion 20a flares outwardly from the cylindrical portion 20b so that the annular body part 14 has a narrow end 24 and a wide end 26. The wide end 26 defines a maximum body outer diameter D2. The edge between the wide end of the body part 14 and the inner surface 22 is chamfered, as shown in FIG. 5.

Three rectangular recesses 28 are formed in the inner surface 22 extending axially from the wide end 26 towards a mid point of the body part 14. The recesses 28 are angularly equally spaced around the inner surface at 120° degree intervals and the rear faces of the three recesses define three points on a notional circle having a diameter D3 (see FIG. 6).

The metal rim 18 is illustrated in detailed in FIGS. 7 and 8. The rim 18, when assembled, is an annular metal plate having an outer surface 30 and an inner surface 32. The outer surface 30 is crenelated, the peaks 34 of the crenelated surface defining a maximum outer diameter D4 (see FIG. 7) and the trough 36 defining a minimum outer diameter D5 (not shown).

The inner surface 32 of the metal rim 18 has six annularly equally spaced teeth 38, spaced at 60° degree intervals. The teeth 38 extend radially inwardly of the rim 18. Alternate teeth 38 carry a pad 40 which is a rectangular plate-like member extending axially of the rim.

The pads 40 are welded to the ends of the teeth 38.

The rim 18 may be formed in one piece by stamping from sheet metal and subsequently welding the pads 40 or, as shown in FIG. 8, the rim 18 can be made of three arcuate pieces each describing 120° degrees of the circular rim. In that case, the pieces preferably have half a tooth 38 at each end and a tooth in the middle thereof and the pieces can be welded together at their opposite ends at the half teeth so as to form teeth 38 and are further secured together by the welding of the pads 40 to the welded teeth. Weld lines 42 are shown in FIG. 8. The rear faces of the pads 40 define a notional circle having a diameter D6 (see FIG. 8) and the inner faces of the pads 40 define a notional circle having a diameter D7 (see FIG. 8).

As shown in FIG. 1, the parts 14, 16 surround the metal rim 18. The parts 14, 16 are arranged so that their wide ends 26 face each other and abut the rim 18. When assembled together, as shown in FIG. 2, the pads 40 are received in the recesses 28. The diameter D3 defined by the rear faces of the recesses 28 is slightly smaller than the diameter D6 defined by the rear faces of the pad 40 so that the pads 40 are received with interference in the recesses 28. The maximum outer diameter D2 of the elastomeric body 12 is smaller than the maximum outer diameter D4 of metal rim 18 so that the peaks of the crenelations 34 protrude from the elastomeric body. In the FIG. 2 embodiment, the minimum outer diameter D5 of the metal rim 18 is also greater than the maximum outer diameter D2 of the elastomeric body so that the entire outer surface 30 of the rim 18 protrudes. In some embodiments it may be desirable for only part of the outer surface 30 of the rim 18 to protrude. The diameter D7 defined by the inner faces of the pads 40 is greater than the diameter D1 of the inner surface of the elastomeric body 12.

FIG. 3 shows six soil treatment apparatuses 10 as described in FIGS. 1, 2 and 5-8 arranged co-axially with their narrow ends 24 in respective abutment. It can be seen that the profile between the metal rims 18 of adjacent soil treatment apparatus takes the form of a diabolo.

FIG. 4 shows a series of soil treatment apparatuses 10 arranged upon an axle 44 in the form of a cylindrical tube 46 rotatably mounted by means of a bearing 48 at each end thereof. The tube 46 has an annular flange 50 at each end thereof and the soil treatment apparatuses are arranged on the tube in axial compression, the axial compression being maintained by the flanges 50. Several soil treatment apparatuses have been omitted for clarity.

The outer diameter of the tube 46 is slightly larger than the inner diameter D1 of the elastomeric body 12 but is smaller than the diameter D7 defined by the inner faces of the plates 40.

When the apparatus is being used to treat the soil, the tube 46 is lowered so that the soil treatment apparatus 10 contacts the soil surface. The metal rims 18 serve to cut clods of soil and break up the soil profile while the elastomeric bodies 12 consolidate the soil profile with the diabolio profile described above. Such an arrangement encourages moisture retention on the soil surface and discourages soil erosion. The axial compression of the apparatuses 10 together prevents ingress of material between the individual apparatuses. Should the metal rim 18 encounter a relatively solid object, for example a submerged stone or bolder, then the rim 18 will deflect. The deflection will be taken up by the inherent resilience of the elastomeric material because the rim is mounted on the elastomeric body, not directly to the axle 44. The maximum deflection permitted by the arrangement is the difference in diameters between the external diameter of the tube 46 and the internal diameter D7 defined by the inner faces of the pads 40. However, by that point, a substantial part of the shock energy will have been absorbed by the resilience of the elastomeric body 12 and that energy will be dissipated as heat. Moreover, the flexible nature of the elastomeric material between the metal rims 18 and the flexible nature of the rims themselves reduces the likelihood of stones sticking between metal rims. The arrangement disclosed has improved self-cleaning. Accordingly, the corrugated nature of the soil treatment apparatuses as shown in FIG. 4 affords the appropriate soil profile with a reduced tendency for the soil to stick which in turn allows for a reduced scraping effort. That, in turn, reduces power requirement and slippage between the roller and the soil surface. In turn this further reduces the soils tendency to stick and to block the soil treatment apparatus.

The primary advantages of the soil treatment apparatus in accordance with the invention are that the advantages of the applicants previous system as described in GB2323511 are maintained whilst reducing the weight of the product and complexity of assembly. The system is considerably lighter and facilitates the use of wider units for each bearing pair. The resiliently mounted metal rim maintains effective clod cutting whilst adsorbing high shock loads in resilient fashion. The flexible mounting of the rim reduces jamming of stones and soil adhesion and thus reduces loadings on bearings and power requirement for drawing the soil treatment apparatus.

The elastomeric body may be formed from any appropriate elastomer. The most preferred material is polyurethane although natural rubber or synthetic rubber may also be used. The metal rim is preferably made from steel. In the embodiment described it is preferred that the elastomer material has a relatively high shore hardness, for example above 50 and most preferably around 70.

An alternative method of manufacturing the soil treatment apparatus comprises manufacturing the metal rim 18, either by stamping in one piece or by welding multiple parts together, as described above, placing the rim 18 in a mould and moulding the elastomeric body 12 around the rim 18 so that parts of the rim 18 protrude radially outwardly of the elastomeric body 12. In such a case, the metal rim 18 may include additional formations to assist in the retention of the rim 18 in the mould or to assist in securing the rim to the elastomeric body. For example, apertures may be formed axially through the teeth 38 so that when the elastomeric material is injected into the mould it flows through the apertures so as to secure the rim 18 in position relative to the elastomeric body 12. Alternatively, or in addition, such apertures could be used to receive retaining pins which form part of the mould so as to ensure retention of the rim in its proper position during the mould process.

Where the rim is moulded into the elastomeric body, there is less requirement for the elastomeric material to be relatively hard and it is possible to select a softer material, for example as described in the applicant's International Patent Application No.WO/02/32209, the contents of which, particularly with relation to the material specification as set out on pages 9 and 10 and in claims 11-18 thereof, are expressly incorporated herein.

In FIG. 9, a soil treatment roller is indicated general at 100. The roller 100 comprises a roller core 110, end plates 112, a series of rings 114 spaced apart and clamped together by means of annular elastomeric clamping members 116.

The roller core 110 comprises a thin walled, steel, elongate, hollow cylinder 118. At each end of the cylinder 118, a plug assembly 120 closes off the end. Each plug assembly 120 carries a bearing assembly 122 shown schematically in FIG. 9. Each plug assembly 120 also includes four screw-threded apertures 124 (two shown). The apertures 124 receive bolts 126 which secure the end plates 112 respectively.

Each end plate 112 is in the form of a flat steel annular disc which has an inner diameter D1 which is less than the inner diameter D2 of the roller core 118 and an outer diameter D3 which is greater than the outer diameter D4 of the roller core 118.

Each ring 114 comprises two ring parts 128 (see FIGS. 11, 12a and 12b).

Each ring part 128 is circular with a circular central aperture 130. The circular central aperture 130 defines an inner rim 132 having a diameter D5 which is a clearance fit around the outer diameter D4 of the roller core 118.

Each ring part 128 comprises a radially extending base part 134 which curves via a radiused part 136 into an axially and radially extending wall part 138. This, in turn, curves via radiused part 140 into a substantially axially extending rim part 142. Whilst the rim part is described as substantially radially extending, it can be seen from FIG. 11 that the rim part 142 does extend with a smaller axial component. The importance of this feature will be discussed below.

In order to form a ring 114, two ring parts 128 are arranged so that their rim parts 142 abut each other and in cross-section have the form of an onion dome in section. The rim parts 142 are arranged to touch at their outermost edge and the slight axial component described above creates a tapered rim to the ring 114. This profile is advantageous since it cuts clods and propagates cracks through the soil surface which serves to prevent top soil run-off. The axially and radially extending wall part 138 creates a consolidated ridge.

The ring parts 128 are not secured together by welding. Rather, they are clamped together by means of an axially compressive force provided by a combination of the end plates 112 and the elastomeric clamping pieces 116.

In use, the ring parts 128 are mounted on the roller core 118 with their rim parts 142 abutting each other so as to form rings 114. Between each ring 114, ie between each pair of ring parts 128, an annular elastomeric member 116 is arranged around the roller core 118.

The annular elastomeric member 116 has an outer diameter D6 which is less than the outer diameter D7 of the ring parts 128. The inner diameter D8 of the annular member 116 is preferably substantially similar to the outer diameter D4 of the roller core 118. In fact, it may be preferable for D8 to be slightly smaller than D4 so that the annular member 116 has to be stretched slightly in order to fit onto the roller 118.

One of the end caps 112 is secured to the roller 110 and the rings 114 and interleaved annular elastomeric members 116 are arranged on the roller 110. The rings and the elastomeric members 116 are dimensioned such that the final ring 114 protrudes over the end of the roller core 118. An axial compression is applied to the rings 114 and the elastomeric members 116 to allow the other end cap 112 to be arranged on the roller 110 and secured thereto. Once the end cap 112 is secured to the roller 110, the rings 114 are held in axial compression by the end caps 112 and the elastomeric members 116.

As described above, the provision of elastomeric members to store the energy of the compressive load results in a safer system when the apparatus is dismantled because of the hysteresis displayed by the elastomeric material. Likewise, the elastomeric member 116 can be used to roll the soil between the ring members 114 and a variety of profiles may be applied to the outer surface of the elastomeric annular member 116 so provide an appropriately profiled ridge member between the gullies formed by the rings 114. The elastomeric members 116 also provide a seal preventing soil ingress into the rings 114.

As the soil treatment roller 100 is used, the rim parts 142 of the ring parts 128 will begin to wear. As the tips of the rims 142 begin to wear, those parts will be held together because the elastomeric members which have been clamped up by the end plates 112 will maintain the compressive force holding the rim parts together. This provides a self-sharpening function similar to that shown in GB2323511 but with the advantage that the centres around which the rings 114 were originally located are maintained and that the axial compressive force is distributed evenly across the width of the roller 110. Eventually, the rim parts 142 wear to such an extent that replacement is required. However, the self-sharpening provided by the elastomeric clamping arrangement extends the life of the rings over, for example, welded rings.

A soil treatment roller 200 is shown in FIGS. 14-18 and parts corresponding to parts in FIGS. 9-13 are numbered 100 higher.

The roller 200 is substantially similar to the roller 100 of FIGS. 9-13 and is not described in detail.

The roller 200 also comprises a roller core 218 closed off by end plates 212 with a series of rings 214 which are held with a compressive axial load effected by the ends plates 212 and annular elastomeric members 216.

The ring parts 228 are substantially identical to the rings part 128 of FIGS. 9-13.

The annular elastomeric members 216 are slightly different from those shown in FIGS. 9-13. In particular, whereas the annular elastomeric members 116 in FIGS. 9-13 had a substantially rectangular cross-sectional profile, the cross-sectional profile of the annular elastomeric members 216 is in the form of a capstan.

The profile is illustrated in FIG. 18c which is cross-section taken on line C-C in FIG. 18a. The profile comprises a substantially rectangular portion 250 with a narrower projecting part 252 which flares outwardly towards the outer peripheral edge 254 of the annular member. That defines a pair of shoulders 256, 258 arranged one each side of the projecting portion 252. The function of the shoulders 256, 258 in the annular member 216 is to provide a mounting for the ring parts 228 (see FIG. 16).

As mentioned above, it can be advantageous to mount the rings onto the roller via the elastomeric member as that provides a mechanism for absorbing shock loading on the rings in the event that they encounter, for example, submerged rocks or boulders. Thus, in the roller of FIGS. 14 to 18, the rings 214 are mounted on the elastomeric members 216 in the manner shown and they are also axially compressed by means of the elastomeric members 216 and the end plates 212. In that way, the roller of FIGS. 14 to 18 enjoys the advantages of both the device of figs.1 to 8 and of FIGS. 9 to 13.

The ring parts 128, 228 are preferably made from wear resistant steel and the elastomeric members 116, 216 are made from a suitable elastomeric material, such as natural or synthetic rubber or a mixture thereof. Recycled vehicle tyre material may be used for the elastomeric material.

1. A soil treatment apparatus comprising a metal ring and an elastomeric clamping arrangement arranged to provide an axial compressive force on the ring.

2. A soil treatment apparatus according to claim 1, in which the ring comprises first and second parts, each part comprising a circular base, a radially and axially extending wall part and a substantially radially extending rim part.

3. A soil treatment apparatus according to claim 2, in which the first and second parts are arranged so that their respective rim parts are in contact.

4. A soil treatment apparatus according to claim 2, in which the first and/or second ring parts are mounted on the elastomeric clamping arrangement.

5. A soil treatment apparatus according to claim 3, in which the first and/or second ring parts are mounted on the elastomeric clamping arrangement.

6. A soil treatment apparatus according to claim 1, in which the apparatus is arranged on an axle.

7. A soil treatment apparatus according to claim 6, in which the ring is mounted on the elastomeric clamping arrangement and the elastomeric clamping arrangement is mounted on the axle.

8. A soil treatment apparatus according to claim 1, in which the elastomeric clamping arrangement comprises a first elastomeric piece on one side of the ring and a second elastomeric piece on the other side of the ring.

9. A soil treatment apparatus according to claim 1 in which the soil treatment apparatus comprises a ring comprising first and second ring parts arranged on an axle, an elastomeric clamping arrangement comprising a first elastomeric piece on one side of the ring and a second elastomeric piece on the other side of the ring, a first stop attachable to the axle on one side of the ring against which the elastomeric clamping arrangement abuts and a second stop attachable to the axle on the other side of the ring against which the elastomeric clamping arrangement abuts.

10. A soil treatment apparatus according to claim 9, in which a plurality of sets of ring parts and elastomeric clamping arrangements is arranged on an axle between the two stops.

11. A soil treatment apparatus according to claim 6 in which the diameter of the axle is greater than half of the diameter of the ring.

12. A soil treatment apparatus according to claim 7 in which the diameter of the axle is greater than half of the diameter of the ring.

13. A soil treatment apparatus according to claim 8, in which the apparatus is arranged on an axle and in which the diameter of the axle is greater than half of the diameter of the ring.

14. A soil treatment apparatus according to claim 9, in which the apparatus is arranged on an axle and in which the diameter of the axle is greater than half of the diameter of the ring.

15. A soil treatment apparatus according to claim 10, in which the apparatus is arranged on an axle and in which the diameter of the axle is greater than half of the diameter of the ring.

16. A soil treatment apparatus according to claim 9, in which one or both of the stops is an end flange.

17. A soil treatment apparatus according to claim 10, in which one or both of the stops is an end flange.

18. A soil treatment apparatus according to claim 1, in which the or each ring is made from wear resistant steel.

19. A soil treatment apparatus according to claim 1, in which the elastomer used in the elastomer clamping arrangement is either natural or synthetic rubber or a mixture of the two.

20. A soil treatment apparatus according to claim 19, in which the elastomer is made from recycled vehicle tyres.

21. A soil treatment apparatus according to claim 1, in which two rings are provided and the elastomeric clamping arrangement comprises a first elastomeric piece on one side of the first ring, a second elastomeric piece between the two rings and a third elastomeric piece on the opposite side of the second ring.

22. A soil treatment apparatus according to claim 1, in which more than two rings are provided and a single elastomeric piece is provided between each pair of rings.

23. A soil treatment apparatus comprising a ring having a first ring part and a second ring part and an elastomeric clamping arrangement to which the first and second ring parts are mounted and which is arranged to clamp the first and second ring parts together to form the ring and to provide an axial compressive force on the parts.

24. A soil treatment apparatus comprising an annular elastomeric body defining an outer soil treatment surface and an annular metal rim mounted on the elastomeric body so that at least part of the rim protrudes radially outwardly of the outer soil treatment surface.

25. A soil treatment apparatus according to claim 24, in which the elastomeric body is provided in two parts, one part on one side of the metal rim and the other part on the other side of the metal rim.

26. A soil treatment apparatus according to claim 25, in which the parts are compressed together around the metal rim.

27. A soil treatment apparatus according to claim 24, in which the elastomeric body is provided in one part.

28. A soil treatment apparatus according to claim 27, in which the metal rim is in-moulded with the body.

29. A soil treatment apparatus according to claim 24, in which the elastomeric body is at least partly frustoconical in section.

30. A soil treatment apparatus according to claim 29, in which the elastomeric body comprises a cylindrical portion and a frustoconical portion.

31. A soil treatment apparatus according to claim 29, in which the soil treatment apparatus comprises an annular elastomeric body having a first portion comprising a cylinder and a frustocone tapering outwardly from the cylindrical portion, the metal rim being mounted to the enlarged diameter part of the frustocone, the elastomeric body comprising a second portion on the other side of the metal rim, with the metal rim mounted to an enlarged diameter part of the frustocone which tapers inwardly away from the metal rim towards a cylinder.

32. A soil treatment apparatus according to claim 31, in which the first portion and second portion are mirror images of each other.

33. A soil treatment apparatus according to claim 24, in which the inner diameter of the annular metal rim is greater than the inner diameter of the annular elastomeric body.

34. A soil treatment apparatus according to claim 33, in which the annular metal rim is mounted on the annular elastomeric body at the inner diameter of the elastomeric body.

35. A soil treatment apparatus according to claim 24, in which the annular metal rim includes a plurality, preferably 3 or more, of pads which extend inwardly from the inner side of the annular rim so as to define the inner diameter of the rim.

36. A soil treatment apparatus according to claim 24, in which the outer side of the rim is a crenelated circle.

37. A soil treatment apparatus according to claim 24, in which the soil treatment apparatus is mounted on an axle, with the annular elastomeric body being mounted on the axle by means of interference fit and the annular metal rim being mounted to the elastomeric body with a clearance between the inner diameter of the rim and the axle.

38. A soil treatment apparatus according to claim 24, in which the apparatus comprises a first annular elastomeric body with a first annular metal rim mounted thereon on an axle and a second annular elastomeric body having a second annular metal rim mounted thereon, on the axle, the first and second annular elastomeric bodies being axially compressed together.

39. A soil treatment apparatus comprising an axle, a first annular elastomeric body having a first annular metal rim mounted thereon and a second annular elastomeric body having a second annular metal rim mounted thereon, the first and second annular elastomeric bodies being axially compressed together.

40. A method of manufacturing a soil treatment apparatus comprising the steps of providing a mould for moulding a body of the apparatus, providing a metal rim of the apparatus, placing the metal rim in the mould and moulding the body around the rim.

41. A soil treatment apparatus according to claim 1 in which the elastomeric clamping arrangement is formed with a profiled outer periphery such as a ridge, channel or teeth.

42. A soil treatment apparatus according to claim 39 in which the elastomeric body is formed with a profiled outer periphery such as a ridge, channel or teeth.
